(19) United States
(12) Patent Application Publication
(10) Pub. No.: US 2008/0262165 A1
(43) Pub. Date: Oct. 23, 2008

(54) PAINT CONSERVATION-RESTORATION COMPOSITION AND METHOD

(76) Inventor: Piotr Koneczny, London (GB)

Correspondence Address: GAUTHIER & CONNORS, LLP, 225 FRANKLIN STREET, SUITE 2300, BOSTON, MA, 02110, US

(21) Appl. No.: 12/103,754

(22) Filed: Apr. 16, 2008

(30) Foreign Application Priority Data
Apr. 18, 2007 (GB) GB0707515.3

(51) Int. Cl. C09D 179/02

(52) U.S. Cl. 525/418

(57) ABSTRACT

Oligomeric or polymeric hindered amine light stabilisers compounds are used to modify the rheology of solvents, resin compositions and paints, particularly those used for art conservation and restoration, by forming a lyotropic liquid crystal phase, the rheology of which can be modified by varying the amount of hindered amine as well as the solvent or the resin itself. The hindered amine compounds are preferably those containing a piperidine ring with one or two alkyl substituents on either side of the ring nitrogen.

### PRIORITY INFORMATION

The present application claims priority to Great Britain Patent Application No. GB07 07515.3, filed on Apr. 18, 2007, all of which is incorporated herein in its entirety.

### BACKGROUND OF THE INVENTION

1. Field of the invention

This invention relates to compositions for use inter alia in the conservation and restoration of paintings and polychromed objects of art; and to methods of their treatment using such compositions.

2. Description of the Prior Art

Various compositions such as varnishes and retouching media are known for protecting and restoring painted surfaces, and in particular paintings. Varnishes comprise a clear resin and solvent, sometimes containing matting agents, plasticizers and light stabilisers. Retouching/inpainting compositions typically comprise a solution of a resin in an organic solvent mixed with dry pigments to replace losses of original paint.

Various polymers such as ketone and aldehyde resins, hydrocarbon resins, acrylic resins and polyvinyl acetate can be dissolved in solvents in different concentrations to make retouching media. Various nonpolar and polar solvents, depending on the kind of resin, can be used to provide a range of retouching/inpainting media.

The use of a simple solution of resin as a retouching/inpainting medium has its limitations. In many cases it is impossible for the conservator-restorer to achieve a perfect match with the original paint. This is due to the difference in the rheology and handling properties of the retouching/inpainting medium to that of the paint used by the artist on the original artwork.

### SUMMARY OF THE INVENTION

It is an object of the invention to provide a retouching/inpainting medium based on a modern, stable, non-ageing resin of which the rheology and handling properties can be modified in order to imitate more precisely the painting technique and effects of particular paintings so that retouched/inpainted portions of a painting will merge seamlessly with the original.

The present invention relates to a range of gels developed for retouching/inpainting of works of art. They provide a retouching/inpainting medium of great versatility that allows the attainment of what was until now impossible to obtain by the use of simple solutions of resins alone.

Properties of the gels can be varied to suit the specific requirements of particular retouching/inpainting situations by changing the concentration of the resin, by adjusting the hardness or softness of the gel and by choosing solvents with different evaporation rates. In this way retouching/inpainting media can be provided which mimic the rheology and handling properties of the painting medium used in the original artwork, and can be used to retouch difficult and complex surfaces.

### DETAILED DESCRIPTION OF THE INVENTION

Various nonploar hydrocarbon solvents such as alkanes, cycloalkanes, arenes and polar solvents both aprotic and protic, in particular alkylene glycol ethers and more particularly propylene glycol ethers, can be used. Propylene glycol ethers are preferred as solvents for their good toxicological profile and their miscibility with other solvents that are commonly used in solutions of resins used for retouching/inpainting.

In one embodiment of the invention, there is provided a composition for use in art conservation and restoration comprising a solution of a thermoplastic resin, the rheology of which is modified by the development of a liquid crystal phase induced by the addition of an oligomeric or polymeric hindered amine compound, the hindered amine compound comprising 0.5% or more by weight of the total composition.

Hindered amine compounds are known for use as light stabilisers (HALS), in art restoration and conservation as well as in many other fields. They are usually used in monomeric form, having typically two amine groups per molecule, and act by scavenging free radicals generated by ultraviolet light.

I have now found that hindered amine compounds in oligomeric or polymeric form can, with suitable solvents, be formed into liquid crystal phase gels which have remarkable properties as rheology modifiers for organic solvents and polymer solutions compositions, and in particular retouching/inpainting media and paints used in the conservation of fine art. The lyotropic liquid crystals of the gel comprise of a hindered amine compound, solvent molecules, and may contain polymer depending on the nature of the resin used.

Lyotropic liquid crystal molecules are amphiphilic compounds characterised by elongate molecules with hydrophilic and lipophilic ends, the molecules clustering in various configurations in solution, according to concentration and temperature, and depending on the type of solvent used.

At low concentration, solutions of lyotropic liquid crystal molecules are unremarkable, with solute molecules distributed randomly throughout the solvent. At higher concentrations the molecules begin to arrange themselves into clusters called micelles which may take the shapes of hollow spheres, rods or disks according to concentration. At moderate concentrations in a polar solvent such as water, molecules tend to cluster in hollow spheres, the surfaces of which are formed by a layer of polar heads dissolved in the water with the inner portion comprising hydrophobic tails screened from the water by the hydrophilic heads. The micelles in turn tend to arrange themselves in regular arrays similar to a cubic crystal lattice. Similar phenomena occur in non-polar solvents, but with the orientation of the molecules reversed.

In the case of the oligomeric/polymeric molecules used according to an embodiment of the present invention, the micelles are anisometric and, depending on the concentration, conditions, type of solvent and additional solutes, arrange themselves giving a variety of structures. As concentration increases, a discontinuous cubic phase (micellar phase) gives way to a hexagonal columnar phase (middle phase) which in turn gives way to a bicontinuous cubic phase and then a lamellar phase or bilayer, with a double layer of molecules aligned with, in a polar solvent, the polar heads of each layer facing away from one another and the non-polar tails facing one another, the orientation again being reversed in a non-polar solvent. Because the sheet-like layers can slide easily past each other, this phase is less viscous than the hexagonal phase, at least in the direction of sliding, despite the lower solvent content.

Further increases in concentration can result in a bicontinuous cubic phase, a reverse hexagonal columnar phase and an inverse cubic phase (inverse micellar phase).

These changes result in changes in the viscosity and rheology of the solvent and polymer solutions, enabling paints and varnishes with a wide variety of different rheologies to be produced. The oligomeric and polymeric hindered amine compounds of the present invention can be used to modify the viscosity and/or rheology of organic solvents, polymer solutions, paints and adhesives.

In some embodiments of the invention, the hindered amine compounds used are heterocyclic compounds, and in particular those containing a piperidine ring in which a tertiary nitrogen atom is hindered by alkyl substitution on the carbon atoms on either side. One such hindered amine has the following structure, described as poly-(N-β-hydroxyethyl-2,2,6,6-tetramethyl-4-hydroxy-piperidyl succinate), or alternatively as a condensation polymer of butanedioic acid with 4-hydroxy-2,2,6,6-tetramethyl-1-piperidineethanol:

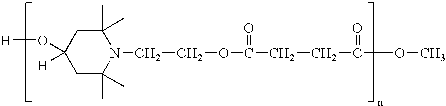

with a number average molecular weight greater than 2,000. This compound is available as a light stabiliser, under the trade mark Tinuvin 622. Another such compound is available under the trade mark Chimassorb 944 and has the following chemical name and structural formula:

Poly-{[6-[(1,1,3,3-tetramethylbutyl)amino]-1,3,5-triazine-2,4-diyl][2,2,6,6-tetramethyl-4-piperidyl)imino]-1,6-hexanediyl[2,2,6,6-tetramethyl-4-piperidyl)imino]}.

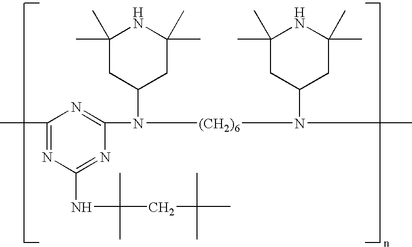

In some embodiments of the invention, this polymer has a number average molecular weight of more than 2,000.

In further embodiments of the invention, the range of contents for the hindered amine compound is 0.5-5.0 wt. %, more preferably 0.7-4.0 wt. %, but amounts up to 10.0 wt. % may be used for some applications and more in certain cases.

One type of composition embodying the present invention is a retouching/inpainting gel comprising a resin such as: a ketone resin, an aldehyde resin, a hydrocarbon resin, polyvinyl acetate or an acrylic resin, a solvent and a rheology modifier dissolved in the solvent to form a liquid crystal phase. The resin is preferably an acrylic resin, for example a copolymer of ethyl/methyl methacrylate available from Rohm & Haas as Paraloid B72, also known as Acryloid B72.

In some embodiments of the invention the solvent is a nonploar hydrocarbon solvent such as alkane, cycloalkane, arene or a polar solvent, aprotic or protic, and preferably a glycol ether and more preferably a propylene glycol ether. Preferred solvents include the following:
Propylene glycol monomethyl ether (1-methoxy-2-propanol)
Propylene glycol n-propyl ether (1-propoxy-2-propanol)
Dipropyleneglycol methyl ether (1-(2-methoxyisopropoxy)-2-propanol)

A hindered amine rheology modifier for a composition in accordance with some embodiments of the invention is the butanedioic acid polymer with 4-hydroxy-2,2,6,6-tetramethyl-1-piperidineethanol. This can suitably be added in an amount of 0.5-5.0 wt. %, depending on the required rheology, to form a liquid crystal phase.

The product range of gels for the retouching/inpainting of works of art may include solutions of a copolymer of ethyl/methylmethacrylate at different concentrations dissolved in 1-methoxy-2-propanol, 1-Propoxy-2-propanol and 1-(2-methoxyisopropoxy)-2-propanol with an addition of various quantities of the butanedioic acid polymer with 4-hydroxy-2,2,6,6-tetramethyl-1-piperidineethanol as a rheology modifier.

The retouching/inpainting gels may vary in concentration of the resin and rheology modifier depending on the application and desired effect. Gels comprising 5.0-7.5 wt. % of the resin and 0.5-1.5 wt. % of the rheology modifier are recommended for the application of artificial dirt. Gels comprising 7.5-20.0 wt. % of the resin and 1.5-3.5 wt. % of the rheology modifier are recommended for painting glazes (thin transparent layers of paint). Gels comprising 10.0-25.0 wt. % of the resin and 2.0-4.0 wt. % of the rheology modifier are recommended for imitating painting with megilp (a traditional painting additive in the form of a gel made of a drying vegetable oil such as linseed oil mixed with mastic varnish, a solvent such as turpentine and siccative). Gels comprising 20.0-35.0 wt. % of the resin and 2.0-5.0 wt. % ofthe rheologymodifier are recommended for painting textures and impastos.

The drying time of the gels is modified by use of a solvent with a different evaporation ratio. The matting agent, preferably fumed silica, is added to some of the gels designated for the retouching/inpainting of absorbent and/or matt surfaces.

As an example, a typical gel for glazing comprises 20.0 wt. % solution of the copolymer of ethyl/methylmethacrylate in 1-Propoxy-2-propanol and 3.0 wt. % of of the butanedioic acid polymer with 4-hydroxy-2,2,6,6-tetramethyl-1-piperidineethanol as a rheology modifier.

The hindered amine rheology modifiers used in accordance with the invention can be used for example to modify the rheology or viscosity of organic solvents, varnishes, paints and adhesives.

What is claimed is:

1. A composition to use in art conservation or restoration comprising a thermoplastic resin, a solvent and 0.5 wt. % or more of an oligomeric or polymeric hindered amine compound, the composition comprising a liquid crystal phase induced by the inclusion of the oligomeric or polymeric hindered amine.

2. A composition according to claim 1 wherein the hindered amine has a number average molecular weight of 2,000 or more.

3. A composition according to claim 1 wherein the oligomeric or polymeric hindered amine compound is included in an amount of 0.5-5.0 wt. % based on the total composition.

4. A composition according to claim 1 wherein the hindered amine compound comprises an oligomer or polymer of butanedioic acid with 4-hydroxy-2,2,6,6-tetramethyl-1-piperidineethanol.

5. A composition according to claim 1 wherein the hindered amine compound comprises poly-{[6-[(1,1,3,3-tetramethylbutyl)amino]-1,3,5-triazine-2,4-diyl][2,2,6,6-tetramethyl-4-piperidyl)imino]-1,6-hexanediyl[2,2,6,6-tetramethyl-4-piperidyl)imino]}.

6. A composition according to claim 1 wherein the resin comprises a ketone resin, an aldehyde resin, a hydrocarbon resin or an acrylic resin or polyvinyl acetate.

7. A composition according to claim 6 wherein the resin is a copolymer of ethyl methacrylate and methyl acrylate.

8. A composition according to claim 1 wherein the solvent is a nonpolar solvent.

9. A composition according to claim 8 wherein the nonpolar solvent is an alkane, cycloalkane or arene.

10. A composition according to claim 1 wherein the solvent is an aprotic or protic polar solvent.

11. A composition according to claim 1 wherein the solvent is a glycol ether.

12. A composition according to claim 11 wherein the solvent is selected from 1-methoxy-2-propanol, 1-propoxy-2-propanol and dipropyleneglycol methyl ether.

13. A method of modifying the rheology of a solvent or a resin solution which comprises developing therein a liquid crystal phase obtained by the addition of 0.5 wt. % or more of an oligomeric or polymeric hindered amine compound.

14. A method of treating a paint layer on an object of art for the purposes of conservation or restoration, which comprises applying to the surface of the painting a composition comprising a thermoplastic resin, a solvent and 0.5 wt. % or more of an oligomeric or polymeric hindered amine compound, the composition comprising a liquid crystal phase induced by the inclusion of the oligomeric or polymeric hindered amine.

15. A method according to claim 14 wherein the hindered amine has a number average molecular weight of 2,000 or more.

16. A method according to claim 14 wherein the oligomeric or polymeric hindered amine compound is included in an amount of 0.5-5.0 wt. % based on the total composition.

17. A method according to claim 14 wherein the hindered amine compound comprises an oligomer or polymer of butanedioic acid with 4-hydroxy-2,2,6,6-tetramethyl-1-piperidineethanol.

18. A method according to claim 14 wherein the hindered amine compound comprises poly-{[6-[(1,1,3,3-tetramethylbutyl)amino]-1,3,5-triazine-2,4-diyl][2,2,6,6-tetramethyl-4-piperidyl)imino]-1,6-hexanediyl[2,2,6,6-tetramethyl-4-piperidyl)imino]}.

19. A method according to claim 14 wherein the resin comprises a ketone resin, an aldehyde resin, a hydrocarbon resin or an acrylic resin or polyvinyl acetate.

20. A method according to claim 19 wherein the resin is a copolymer of ethyl methacrylate and methyl acrylate.

21. A method according to claim 14 wherein the solvent is a nonpolar solvent.

22. A method according to claim 21 wherein the nonpolar solvent is an alkane, cycloalkane or arene.

23. A method according to claim 14 wherein the solvent is an aprotic or protic polar solvent.

24. A method according to claim 14 wherein the solvent is a glycol ether.

25. A method according to claim 24 wherein the solvent is selected from 1-methoxy-2-propanol, 1-propoxy-2-propanol and dipropyleneglycol methyl ether.
